(19) United States
(12) Patent Application Publication
(10) Pub. No.: US 2008/0288220 A1
(43) Pub. Date: Nov. 20, 2008

(54) USE OF A THREE-DIMENSIONAL (3D) DATA CENTER TO SHARE SERVICE OPERATIONS

(76) Inventors: Donna N. Dillenberger, Yorktown Heights, NY (US); Robert M. Greenberg, Raleigh, NC (US); Mark F. Hulber, New York, NY (US); Michael J. Osias, Westtown, NY (US)

Correspondence Address: HOFFMAN WARNICK LLC, 75 State Street, 14th Floor, ALBANY, NY, 12207, US

(21) Appl. No.: 11/750,216

(22) Filed: May 17, 2007

(51) Int. Cl. G06F 17/50

(52) U.S. Cl. 703/1

(57) ABSTRACT

The present invention creates and/or uses a 3D data center that mirrors physical operations that may not all be co-located in one physical space. The 3D data center can cluster geographically dispersed similar physical assets into one area of the 3D data center, e.g., all of a company's physical world wide mainframes on one virtual floor of the 3D data center. Human experts that reside anywhere geographically could enter the 3D data center, service, manage, monitor their physical machines and applications and/or train other individuals living in different geographical locations, or working for other companies.

### CROSS-REFERENCE TO RELATED APPLICATIONS

This application is related in some aspects to commonly owned patent application Ser. No. 11/747,147 entitled “HOLOGRAPHIC ENTERPRISE NETWORK”, assigned attorney docket number END92000184US1, filed May 10, 2007, the entire contents of which are herein incorporated by reference.

This application also is related in some aspects to commonly owned patent application Ser. No. 11/747,157, entitled “VIRTUAL NETWORK OPERATIONS CENTER”, assigned attorney docket number END920070185US1, filed May 20, 2007, the entire contents of which are herein incorporated by reference.

This application also is related in some aspects to commonly owned patent application Ser. No. 11/747,182, entitled “MANAGEMENT OF ENTERPRISE SYSTEMS AND APPLICATIONS USING THREE-DIMENSIONAL VISUALIZATION TECHNOLOGY”, assigned attorney docket number END920070188US1, filed May 10, 2007, the entire contents of which are herein incorporated by reference.

This application also is related in some aspects to commonly owned patent application number (to be provided), entitled “USE OF THREE-DIMENSIONAL DATA CENTER TO SUPPORT SERVICING OUTSOURCED OPERATIONS”, assigned attorney docket number YOR920070259US1, filed concurrently herewith, the entire contents of which are herein incorporated by reference.

### FIELD OF THE INVENTION

The present invention generally relates to enterprise systems and applications and more specifically to using three-dimensional (3D) visualization technology to provide an enterprise manager with streaming visual representations of aspects of an enterprise in near real-time.

### BACKGROUND OF THE INVENTION

Expertise in specific hardware, software and network configurations require years to master. The experience to become a skilled mainframe operator or storage analyst or application administrator may reside in disparate physical locations. Resolving problems and providing successful service operations may depend on bringing a group of skills together to view the problem using real data and actual deployed configurations. Current solutions to this problem are to: (1) locate the skilled person(s) and transport them to the client location; (2) invest in creating the skilled expertise in every provider location that requires the service; and/or (3) debug the problem or walk the local provider through the scenario remotely (e.g., on the phone, using email, etc.) as much as possible, guessing what the local people are not stating in terms of relevant data and configuration.

Unfortunately, existing approaches are time-consuming, costly, and/or error prone. In view of the foregoing, there exists a need for an approach that solves at least one of the afore-mentioned deficiencies in the related art.

### SUMMARY OF THE INVENTION

In general, the present invention creates and/or uses a 3D data center that mirrors physical operations that may not all be co-located in one physical space. The 3D data center can cluster geographically dispersed similar physical assets into one area of the 3D data center, e.g., all of a company's physical world wide mainframes on one virtual floor of the 3D data center. Human experts that reside anywhere geographically could enter the 3D data center, service, manage, monitor their physical machines and applications and/or train other individuals living in different geographical locations, or working for other companies.

Specifically, software monitors the hardware and/or software of the physical assets, aggregates disparate sources of data, optionally applies logic to interpret and analyze the data and sends the data to the 3D data center, which renders the different sources of data into easy to understand and easy to operate visual renditions of the data center operations. The 3D data center allows software (e.g., applications) and/or hardware to be grouped according to their model type, and/or classification, any category which allows for experts in a geographical area to enter the 3D rendition and manage, monitor and/or train other individuals in this virtual visual setting.

A first aspect of the present invention provides a method of using a three-dimensional (3D) data center to share service operations, comprising: monitoring hardware and software of a computer enterprise to obtain corresponding data; identifying and aggregating disparate sources of data of the computer enterprise based on the monitoring; rendering the data into a virtual visual representation; and grouping the hardware and the software to provide at least one of: management of, monitoring of, or training on the computer enterprise.

A second aspect of the present invention provides a system for using a three-dimensional (3D) data center to share service operations, comprising: a module for monitoring hardware and software of a computer enterprise to obtain corresponding data; a module for identifying and aggregating disparate sources of data of the computer enterprise based on the monitoring; and a module for sending the data to the 3D data center.

A third aspect of the present invention provides a program product stored on at least one computer readable medium for using a three-dimensional (3D) data center to share service operations, the at least one computer readable medium comprising program code for causing at least one computer system to: monitor hardware and software of a computer enterprise to obtain corresponding data; identify and aggregate disparate sources of data of the computer enterprise based on the monitoring; render the data into a virtual visual representation; and group the hardware and the software to provide at least one of: management of, monitoring of, or training on the computer enterprise.

A fourth aspect of the present invention provides a method for deploying a system for using a three-dimensional (3D) data center to share service operations, comprising: providing a computer infrastructure being operable to: monitor hardware and software of a computer enterprise to obtain corresponding data; identify and aggregate disparate sources of data of the computer enterprise based on the monitoring; render the data into a virtual visual representation; and group the hardware and the software to provide at least one of: management of, monitoring of, or training on the computer enterprise.

A fifth aspect of the present invention provides computer software embodied in a propagated signal for using a three-dimensional (3D) data center to share service operations, the computer software comprising instructions for causing at least one computer system to: monitor hardware and software of a computer enterprise to obtain corresponding data; identify and aggregate disparate sources of data of the computer enterprise based on the monitoring; render the data into a virtual visual representation; and group the hardware and the software to provide at least one of: management of, monitoring of, or training on the computer enterprise.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a high-level schematic diagram showing an architectural overview of a system for streaming visual representations of an enterprise in near-real time according to an aspect of the present invention.

FIG. 2 shows a more detailed view of a holographic enterprise interface shown in FIG. 1.

FIG. 3 shows a system for using a data center to share service operations according to an aspect of the present invention.

FIG. 4 provides a visualization of a data center that shows components of an enterprise generated from the system shown in FIG. 1 according to an aspect of the present invention.

FIG. 5 shows a more specific computerized implementation according to an aspect of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:
I. General Description
II. Computerized Implementation

### I. General Description

As indicated above, the present invention creates and/or uses a 3D data center that mirrors physical operations that may not all be co-located in one physical space. The 3D data center can cluster geographically dispersed similar physical assets into one area of the 3D data center, e.g., all of a company's physical world wide mainframes on one virtual floor of the 3D data center. Human experts that reside anywhere geographically could enter the 3D data center, service, manage, monitor their physical machines and applications and/OR train other individuals living in different geographical locations, or working for other companies.

Specifically, software monitors the hardware and/or software of the physical assets, aggregates disparate sources of data, optionally applies logic to interpret and analyze the data and sends the data to the 3D data center, which renders the different sources of data into easy to understand and easy to operate visual renditions of the data center operations. The 3D data center allows software (e.g., applications) and/or hardware to be grouped according to their model type, and/or classification, any category which allows for experts in a geographical area to enter the 3D rendition and manage, monitor and/or train other individuals in this virtual visual setting.

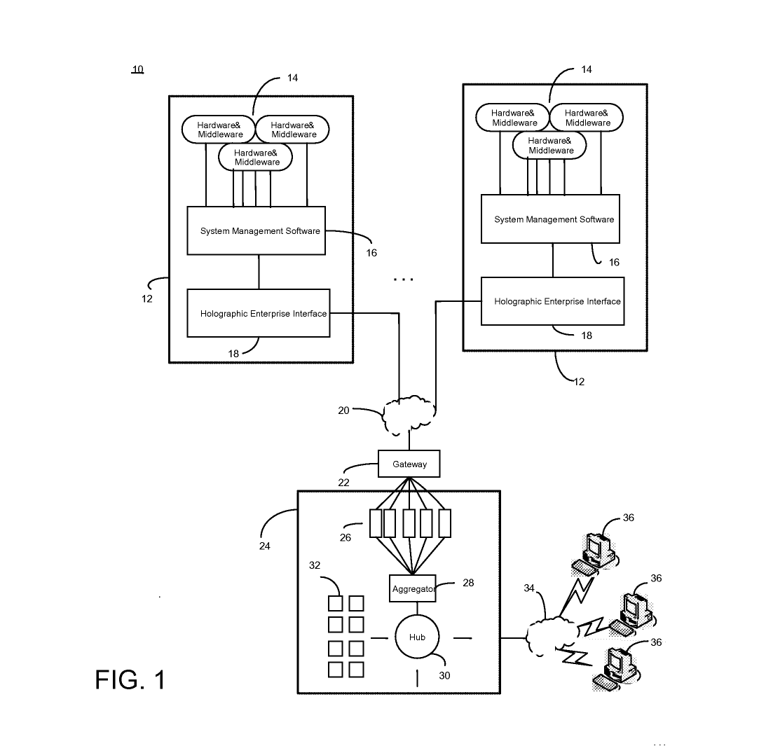

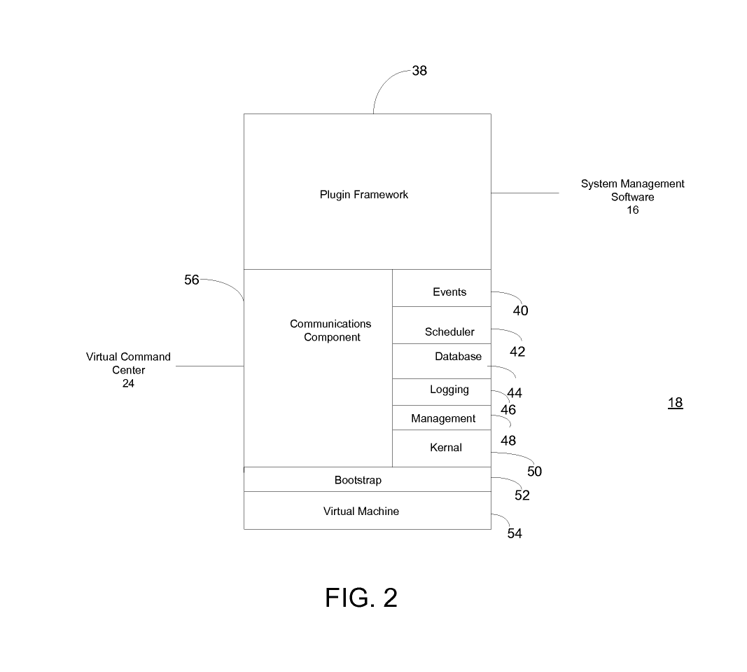

FIGS. 1-2 and their corresponding description are also given in the above-incorporated patent application identified by attorney docket number END920070188US1. They are shown and described below for additional reference and use in conjunction with the present invention.

FIG. 1 shows a high-level schematic diagram showing an architectural overview of a system 10 for streaming visual representations of an enterprise in near-real time according to one embodiment of this disclosure. As shown in FIG. 1, system 20 comprises a plurality of geographically distributed enterprises data centers 12. Each data center 12 is responsible for managing hardware and software elements within a portion of the enterprise. The hardware and software elements are represented in FIG. 1 as hardware and middleware 14. Within each of the data centers 12 is system management software 16 that manages the hardware and software elements. In one embodiment, the system management software 16 includes a plurality of commercially available back-end enterprise systems that are used to manage hardware and software elements within an enterprise.

A holographic enterprise interface 18 is deployed at data center 12. In one embodiment, the holographic enterprise interface 18 is a plug-in based component, where the plug-ins connect to the system management software 16 or more specifically, to each of the back-end enterprise systems. In operation, the holographic enterprise interface 18 transforms information from the application programming interfaces of the back-end enterprise systems into event data which is subsequently dispatched to the manager of the holographic enterprise interface 18. In one embodiment, the plug-ins are subclassed from a plug-in base class which contains interfaces for managing the plug-in instances.

The plug-in manager within the holographic enterprise interface 18 routes the plug-in generated events to the underlying communications systems within the holographic enterprise interface. The plug-in manager 18 also parses an XML configuration file that is the plug-in descriptor defining what plug-ins to load. The communications system within the holographic enterprise interface 18 contains components for encoding event data from the plug-ins into a Holographic Protocol Architecture. The Holographic Protocol Architecture (HPA) is a protocol specification that defines packet types and conversation patterns necessary to interact with a virtual command center 24 via a communications network 20 and gateway 22. In an embodiment, the HPA comprises a packet header detailing the packet type (4 bytes), sequence number (2 bytes), total packets (2 bytes), and a location id (2 bytes).

After the packet header is a tuple based data payload of varying length, based on constraints that may be introduced by the underlying transport. The communications system within the holographic enterprise interface 18 includes a protocol handler that encodes the data from an event system into the HPA. It also decodes the protocol and dispatches events to plug-ins when receiving communications from the virtual command center 24. In addition, there is a packet driver that uses a pluggable cipher component to encrypt the packet. It then interfaces with a pluggable transport provider, such as XML-RPC, to dispatch the communications to the virtual command center 24.

The following configuration enables the virtual command center 24 to operate in synchronous or asynchronous mode with the holographic interface element 18 depending on the underlying transport. In synchronous mode, queuing mechanisms are used to batch transmissions inbound to the holographic interface element 18 from the virtual command center 24. In the event of a stateless synchronous transport, the queued data is encoded into the response to the XML-RPC call, and processed by the communications system within the holographic interface element 18.

FIG. 2 shows a more detailed view of a holographic enterprise interface 18 shown in FIG. 1. In particular, FIG. 2 shows the software components within the holographic enterprise interface 18 that perform the above-noted functions. A more detailed description is provided in the above-incorporated application identified by attorney docket number END920070184US1.

Referring back to FIG. 1, the virtual command center 24 which in one embodiment is a 3D simulator grid 24 that structurally organizes elements of the enterprise into a 3D space. Although FIG. 1 shows the 3D simulator grid 24 separate from the data centers 12, the simulator grid may exist at one of the data centers or at another third party location such as a hosting provider.

The 3D simulator grid 24 has the characteristics of managing a 3D vector space in which objects are placed. These objects are based on elementary geometric shapes and conic sections. They can be manipulated by applying transforms. They can be linked together to form composite objects. Objects can have scripts that are attached to them and govern their behavior. Objects can listen on 65535 channels for messages coming from the simulator environment. Objects can manage their own state.

In addition, the 3D simulator manages the state, script execution, in-world communications, and off-world communications to multiple 3D clients. In one embodiment, multiple simulators can be run on a grid in a parallel processing configuration. In this embodiment, grid infrastructure services manage the quality of service, provisioning, and deployment of simulator instances. Referring back to FIG. 1 for more details of the virtual command center 24 (i.e., the 3D simulator), there is a channel bank 26 that receives the event data generated from each of the data centers 12 via the communications network 20 and gateway 22. The communications gateway 22 routes data to simulator instances that contain the object possessing the UUID of the recipient identified in the message header. Each channel bank 26 is assigned a channel to a data center 12 based on the UUID of the channel bank. As a result, each channel bank 26 receives data from the gateway 22 based on its UUID. An aggregator 28 receives the event data from the channel bank 26. The aggregator 28 aggregates the event data into a composite dataset representative of current operation of the hardware and software elements that are managed by each data center 12.

A communications hub 30 receives the composite data from the aggregator 28 and decrypts and decodes the packets represented by the composite data. In addition, the communications hub 30 receives communications from other sources such as an in-world virtual network 34, 3D equipment models 32 that mimic real world equipment and software, or other sources. These communications are dispatched to an outbound queue for immediate transmission to the holographic enterprise interface 18 or dispatched on the response string of a stateless synchronous transport.

In one embodiment, the equipment models 32 are placed within proximity to a repeater. In this embodiment, the equipment models 32 listen on assigned frequencies for messages of interest. The applicability of a particular message to a model such as a server can be based on its name, IP address, or another token. As a result, the models can be built from the event data received from the data center. Instead of learning the models, it is possible to import the 3D models from other sources. In any event, the models are used to compare to the composite event data received by the communications hub 30. Any differences determined by the hub 30 are indicative of potentially troubling operation of the data center 12, hardware and middleware 14, system management software 16, or holographic enterprise interface 18. In one embodiment, equipment models and software visualizations can dispatch messages to repeaters by speaking on the appropriate channel. Ultimately these messages are sent to the communications hub for processing, and are handled in-world or sent to a holographic enterprise interface 18.

The communications hub 30 is configured to generate a visualization of both the composite data received from the data centers 12 and any differences that may exist with the 3D models 32. The visualization comprises a 3D composite visual image(s) of the current operation of the enterprise. This visual representation is transmitted to users assigned to manage the enterprise via a communications network 34 and computing units 36. A rendering client operating on the computing units 36 then renders the visualization generated by the visual command center 24. In particular, this rendering client connects to a simulator instance and transmits a protocol which allows the client to render the state of the virtual command center 24 (3D simulator). The protocol includes information such as position and size of objects, textures, images, and animations, and other details necessary to render the 3D world. Those skilled in the art will recognize that different simulators use different protocols and that the virtual command center 24 of this disclosure is not dependent on any specific protocol type or implementation.

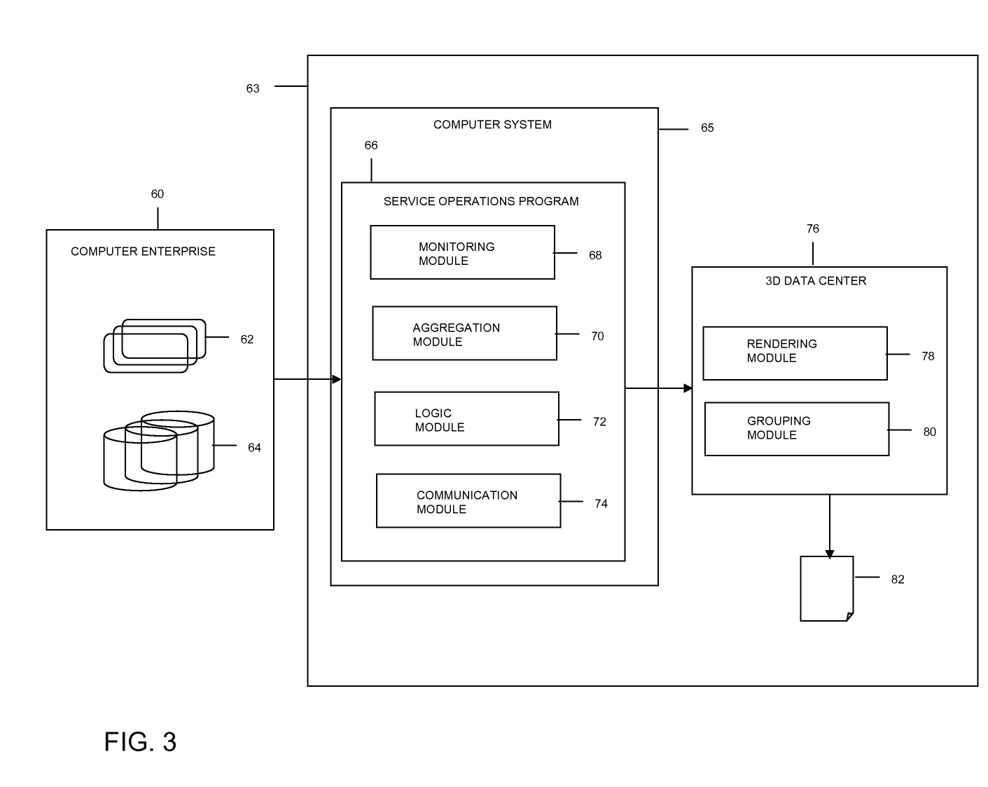

Referring now to FIG. 3, a system for using a 3D data center 76 to share service operations according to the present invention is shown. In general, computer system 65 contains computer program code such as service operations program 66 that will (among other things) monitor and aggregate data corresponding to hardware 64 and software 62 of computer enterprise 60 and send data to 3D data center 76 for generation of a virtual visual representation 82 corresponding to computer enterprise 60. It should be understood that although computer system 65 and 3D data center 76 are shown in a common infrastructure 63 that does no include computer enterprise 60, this need not be the case. For example, computer enterprise 60, computer system 65, and 3D data center 76 could all be deployed in a common computer infrastructure such as computer infrastructure 63, or any number of separate computer infrastructures.

In any event, monitoring module 68 will monitor hardware 64 (e.g., disparate sources of data) and software 62 (e.g., programs and/or modules) of computer enterprise 60 to obtain corresponding data. Typically, this data corresponds to at least one of: a configuration, a location, or an operation of hardware 64 and/or software 62. Aggregation module 70 will identify and aggregate the disparate sources of data of the computer enterprise 60 based on the monitoring (e.g., using the data). Along these lines, logic module 72 can be used to interpret and analyze the data. Regardless, communication module 74 will send the data to 3D data center 76. Upon receipt, rendering module 78 will render a virtual visual representation 82 corresponding to computer enterprise 60 (e.g., of hardware 64 and/or software 62) using the data. This will allow hardware 64 and software 62 to be grouped via grouping module 80 to provide at least one of: management of, monitoring of, or training for computer enterprise 60. Such grouping can be based on any number of factors such as a model type, a classification, or a geographic area of software 62 and/or hardware 64.

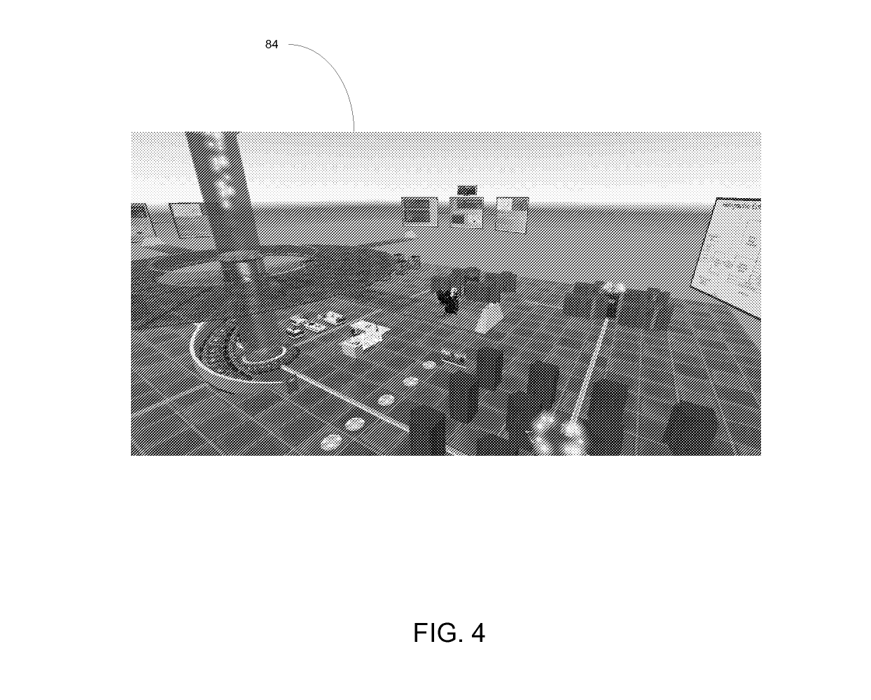

FIG. 4 provides a more detailed view of virtual visual representation 84. In particular, the visualization shows key components of computer enterprise 60 (FIG. 3). As shown in FIG. 4, screens, displays, and data towers are positioned in strategic locations around the command center for providing an overall understanding of the enterprise. The screens, displays, and data towers consume data from the virtual network and determine what types of information to display to the enterprise manager and other personnel responsible for managing the enterprise.

### II. Computerized Implementation

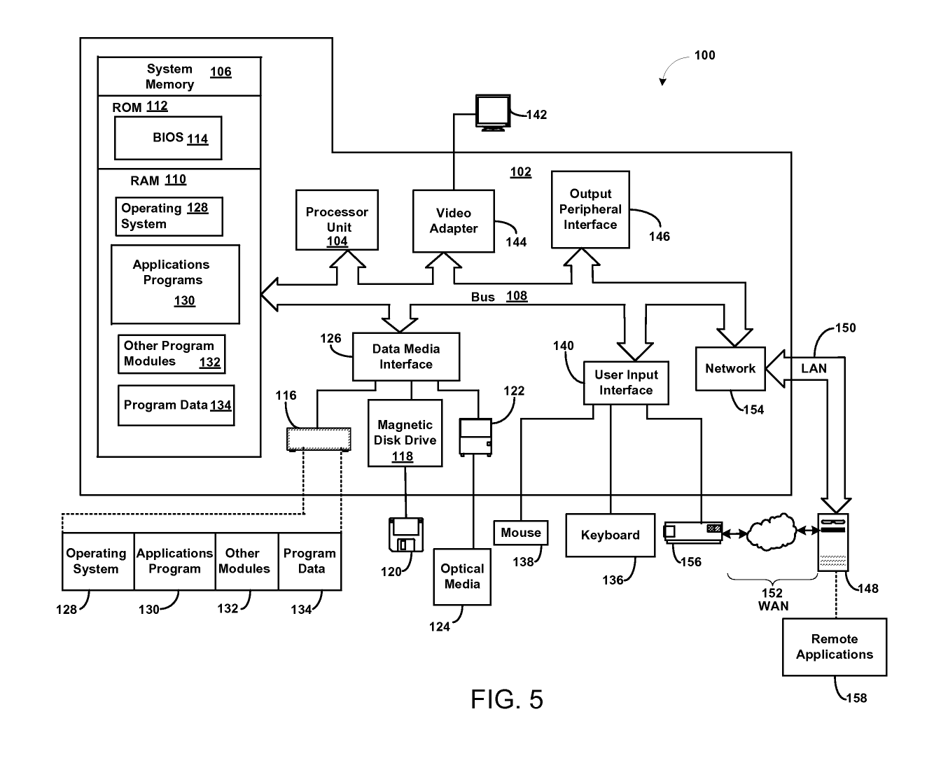

FIG. 5 shows a more specific schematic of a computing infrastructure 100 (e.g., such as computer infrastructure 63) in which elements of the system(s) shown in FIG. 1-4 may operate. The exemplary computing infrastructure 100 is only one example of a suitable computing infrastructure and is not intended to suggest any limitation as to the scope of use or functionality of the approach described herein. Neither should the computing infrastructure 100 be interpreted as having any dependency or requirement relating to any one or combination of components illustrated in FIG. 5.

In the computing infrastructure 100 there is a computer system 102 (e.g. such as computer system 65 of FIG. 3) which is operational with numerous other general purpose or special purpose computing system infrastructures or configurations. Examples of well known computing systems, infrastructures, and/or configurations that may be suitable for use with an exemplary computer system 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing infrastructures that include any of the above systems or devices, and the like.

The exemplary computer system 102 may be described in the general context of computer-executable instructions, such as program modules shown in FIG. 3, being executed by a computer. Generally, program modules include routines, programs, objects, components, logic, data structures, and so on, that perform particular tasks or implement particular abstract data types. The exemplary computer system 102 may be practiced in distributed computing infrastructures where tasks are performed by remote processing devices that are linked through a communications network. In a distributed computing infrastructure, program modules may be located in both local and remote computer storage media including memory storage devices.

As shown in FIG. 5, the computer system 102 in the computing infrastructure 100 is shown in the form of a general-purpose computing device. The components of computer system 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system 102 typically includes a variety of computer readable media. Such media may be any available media that is accessible by computer system 102, and it includes both volatile and non-volatile media, removable and non-removable media.

In FIG. 5, the system memory 106 includes computer readable media in the form of volatile memory, such as random access memory (RAM) 110, and/or non-volatile memory, such as ROM 112. A BIOS 114 containing the basic routines that help to transfer information between elements within computer system 102, such as during start-up, is stored in ROM 112. RAM 110 typically contains data and/or program modules that are immediately accessible to and/or presently operated on by processor 104.

Computer system 102 may further include other removable/non-removable, volatile/non-volatile computer storage media. By way of example only, FIG. 5 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer system 102. Although the exemplary infrastructure described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating infrastructure.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 (e.g., service operations program 66), other program modules 132, and program data 134 or some combination thereof, may include an implementation of the system 10 shown in FIG. 1 for streaming visual representations of an enterprise in near-real time.

A user may enter commands and information into computer system 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer system 102 may operate in a networked infrastructure using logical connections to one or more remote computers, such as a remote server/computer 148. Remote computer 148 may include many or all of the elements and features described herein relative to computer system 102.

Logical connections shown in FIG. 5 are a local area network (LAN) 150 and a general wide area network (WAN) 152. Such networking infrastructures are commonplace in offices, enterprise-wide computer networks, intranets, and the Internet. When used in a LAN networking infrastructure, the computer system 102 is connected to LAN 150 via network interface or adapter 154. When used in a WAN networking infrastructure, the computer typically includes a modem 156 or other means for establishing communications over the WAN 152. The modem, which may be internal or external, may be connected to the system bus 108 via the user input interface 140 or other appropriate mechanism.

In a networked infrastructure, program modules depicted relative to the personal computer system 102, or portions thereof, may be stored in a remote memory storage device. By way of example, and not limitation, FIG. 5 illustrates remote application programs 158 as residing on a memory device of remote computer 148. It will be appreciated that the network connections shown and described are exemplary and other means of establishing a communications link between the computers may be used.

Application programs 130 may be stored on or transmitted across some form of computer readable media. Computer readable media/ium can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. It is understood that the terms computer-readable medium or computer useable medium comprises one or more of any type of physical embodiment of the program code.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

While shown and described herein as a method, system, and program product for using a 3D data center to share service operations, it is understood that the invention further provides various alternative embodiments. For example, in one embodiment, the invention provides a computer-readable/useable medium that includes computer program code to enable a computer infrastructure to user a 3D data center to share service operations. To this extent, the computer-readable/useable medium includes program code that implements each of the various process of the invention.

In another embodiment, the invention provides a business method that performs the process of the invention on a subscription, advertising, and/or fee basis. That is, a service provider, such as a Solution Integrator, could offer to use a 3D data center to share service operations. In this case, the service provider can create, maintain, support, etc., a computer infrastructure, such as computer infrastructure 63 (FIG. 3) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for using a 3D data center to share service operations. In this case, a computer infrastructure, such as computer infrastructure 63 (FIG. 3), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 65 (FIG. 3), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

It is apparent that there has been provided with this disclosure an approach for management of enterprise systems and applications using three-dimensional visualization technology. While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

We claim:

1. A method of using a three-dimensional (3D) data center to share service operations, comprising:
monitoring hardware and software of a computer enterprise to obtain corresponding data;
identifying and aggregating disparate sources of data of the computer enterprise based on the monitoring;
rendering the data into a virtual visual representation; and
grouping the hardware and the software to provide at least one of: management of, monitoring of, or training on the computer enterprise.

2. The method of claim 1, further comprising:
applying logic to interpret and analyze the data; and
sending the data to the 3D data center prior to the rendering.

3. The method of claim 2, the rendering being performed at the 3D data center.

4. The method of claim 1, the grouping comprising grouping the hardware and the software based on at least one of: a model type, a classification, or a geographic area.

5. The method of claim 1, the data corresponding to at least one of: a configuration, a location, or an operation of the hardware and the software.

6. A system for using a three-dimensional (3D) data center to share service operations, comprising:
a module for monitoring hardware and software of a computer enterprise to obtain corresponding data;
a module for identifying and aggregating disparate sources of data of the computer enterprise based on the monitoring; and
a module for sending the data to the 3D data center.

7. The system of claim 6, further comprising a module for applying logic to interpret and analyze the data.

8. The system of claim 6, further comprising:
a module for rendering the data into a virtual visual representation; and
a module for grouping the hardware and the software to provide at least one of: management of, monitoring of, or training on the computer enterprise.

9. The system of claim 8, the module for rendering being implemented at the 3D data center.

10. The system for 8, the module for grouping being adapted to group hardware and the software based on at least one of: a model type, a classification, or a geographic area.

11. The system of claim 6, the data corresponding to at least one of: a configuration, a location, or an operation of the hardware and the software.

12. A program product stored on at least one computer readable medium for using a three-dimensional (3D) data center to share service operations, the at least one computer readable medium comprising program code for causing at least one computer system to:
monitor hardware and software of a computer enterprise to obtain corresponding data;
identify and aggregate disparate sources of data of the computer enterprise based on the monitoring;
render the data into a virtual visual representation; and
group the hardware and the software to provide at least one of: management of, monitoring of, or training on the computer enterprise.

13. The program product of claim 12, the at least one computer readable medium further comprising program code for causing the at least one computer system to:
apply logic to interpret and analyze the data; and
send the data to the 3D data center.

14. The program product of claim 12, the at least one computer readable medium further comprising program code for causing the at least one computer system to group the hardware and the software based on at least one of: a model type, a classification, or a geographic area.

15. The program product of claim 12, the data corresponding to at least one of: a configuration, a location, or an operation of the hardware and the software.

16. A method for deploying a system for using a three-dimensional (3D) data center to share service operations, comprising:
providing a computer infrastructure being operable to:
monitor hardware and software of a computer enterprise to obtain corresponding data;
identify and aggregate disparate sources of data of the computer enterprise based on the monitoring;
render the data into a virtual visual representation; and
group the hardware and the software to provide at least one of:
management of, monitoring of, or training on the computer enterprise.

17. The method of claim 16, the computer infrastructure being further operable to:
apply logic to interpret and analyze the data; and
send the data to the 3D data center.

18. The method of claim 16, the computer infrastructure being further operable to group the hardware and the software based on at least one of: a model type, a classification, or a geographic area.

19. The method of claim 18, the computer infrastructure being further operable to group the hardware and the software on the virtual visual representation.

20. The method of claim 16, the data corresponding to at least one of: a configuration, a location, or an operation of the hardware and the software.
